(19) United States
(12) Patent Application Publication
(10) Pub. No.: US 2022/0332498 A1
(43) Pub. Date: Oct. 20, 2022

(54) LOAD COLLECTING DEVICE

(71) Applicant: ACI CHEMICALS ASIA INC., Seoul (KR)

(72) Inventor: Hyun Soo KIM, Seoul (KR)

(73) Assignee: ACI CHEMICALS ASIA INC., Seoul (KR)

(21) Appl. No.: 17/762,377

(22) PCT Filed: Oct. 18, 2019
(86) PCT No.: PCT/KR2019/013711

§ 371 Date: Mar. 22, 2022

(30) Foreign Application Priority Data
Oct. 18, 2019 (KR) 10-2019-0129638

(51) Int. Cl. B65F 1/14; B65F 1/16

(52) U.S. Cl. CPC B65F 1/1405; B65F 1/16; B65F 2210/168; B65F 2210/20; B65F 2210/162

(57) ABSTRACT

The present invention discloses a load collecting device comprising: a case having an input port formed on one side thereof into which a load is put; a collecting unit disposed inside the case, and having an open top and an accommodation space which accommodates the load; an input unit arranged adjacent to the input port in the case, selectively rotating to open the input port, and transferring the load to the collecting unit; a pressing unit disposed on the top of the collecting unit, and of which at least a part of selectively lowers to pressurize the load accommodated in the collecting unit; and a sensing control unit sensing a load amount of the load accommodated in the collecting unit and controlling the pressing unit so as to selectively press the load.

### TECHNICAL FIELD

The present invention relates to a load collecting device that increases a load amount by sensing the load amount of loads accommodated therein and by selectively compressing loads, and that transmits overload to a server so that a collection unit is replaced when loads are loaded over a reference level.

### BACKGROUND ART

Recently, large residential districts including apartments, high-story buildings, or the like are increasing, and a large amount of loads are produced in comparison to the households in such large residential districts.

In particular, the amount of wastes coming out from each household increases, but the spaces that can receive and keep the wastes are considerably limited due to rot, stink, etc.

Accordingly, a conventional method that a collection container with a cover is provided at a specific area and users put wastes into the collection container in person has been used. However, when only a collection container is simply provided to collect wastes, animals such as cats and dogs damage the collection container or the sanitary state is bad due to rot by propagation of bacteria, stink, etc.

In order to solve this problem, automatic opening-type collection containers having a metallic external shape have been recently developed and used.

In detail, an automatic opening-type collection container is configured to automatically open the cover after recognizing the information of a user, unlike the existing collection containers, so the inside is sealed in other cases.

Accordingly, it is possible to prevent contamination and damage due to animals and prevent leakage of stink by sealing the inside from the outside.

However, the automatic opening-type collection container has a problem that it is difficult to solve the sanitary problem and the problem of stink because it is impossible to know the load amount of wastes collected therein, and accordingly, wastes are taken away at predetermined dates.

Therefore, it is required to develop a device that makes it possible to check the collection amount of wastes loaded therein and immediately take away wastes when the amount of waste becomes a predetermined level or more.

### DISCLOSURE

### Technical Problem

The present invention has been made in an effort to solve the problems in the related art, and provides a load collecting device that can increase a load amount by sensing the load amount of loads accommodated therein and selectively compressing the loads, that can prevent damage to loads by loading loads such that the loads are not compressed over a predetermined level on the basis of resistance measured in pressing, and that enables loads to be immediately taken away by transmitting overload to a server when the load amount is a reference level or more.

The problems of the present invention are not limited to those described above and other problems not described may be clearly understood by those skilled in the art from the following description.

### Technical Solution

The present invention to achieve the above objectives relates to a load collecting device, which includes: a case having an input port formed on one side thereof into which a load is put; a collecting unit disposed inside the case and having an open top and an accommodation space which accommodates the load; an input unit disposed adjacent to the input port in the case, selectively rotating to open the input port, and transferring the load to the collecting unit; a pressing unit disposed on the top of the collecting unit and pressing the load accommodated in the collecting unit by at most partially moving down; and a sensing control unit sensing a load amount of the load accommodated in the collecting unit and controlling the pressing unit so as to selectively press the load.

The sensing control unit may include a load sensor sensing a load height of the load accommodated in the collecting unit, and a controller controlling whether to operate the pressing unit.

In addition, the sensing control unit may control the pressing unit to stop moving down and return to an initial position when resistance acting due to the load is a predetermined setting value or more when the pressing unit is moved down.

The controller may control the pressing unit to move down at a uniform speed and may calculate a collection amount of loads loaded in the collecting unit on the basis of time taken by the pressing unit to return to the initial position after starting moving down.

In addition, the controller may calculate a collection amount of loads loaded in the collecting unit by sensing a descending length of the pressing unit from the initial position to the final descending position.

The input port may include: a rotary bowl having a seat space in which the load is seat, having an opening on a side, having a rotary shaft disposed in a width direction, and rotating in the case; and a driver disposed in the case and rotating the rotary bowl, in which the rotary bowl may block the input port or the opening and the input port may communicate with each other, depending on a rotation angle of the rotary bowl.

The rotary bowl may have a top and a bottom around the opening, and when the opening is rotated down, the load seated in the seat space may drop down and the top may block the input port.

In addition, the rotary bowl may have a bottom and a top around the opening, and when the opening is positioned to face a front and communicates with the input port, the load may be seated in the seat space.

The pressing unit may include: a pressing member having a predetermined area over the collecting unit and pressing the load by selectively moving up and down; a stretcher configured to be able to selectively stretch and contract over the pressing member and moving up and down the pressing member; and a measurer measuring resistance acting when the pressing member presses the load, and informing the sensing control unit that the resistance is a predetermined setting value or more when the resistance is the predetermined setting value or more so that the pressing member is returned to an initial position.

The load collecting device may further include at least one or more energy storage units disposed on the case, collecting and converting sunlight or solar heat into power, and storing the power.

The case may further include a recognizer at least partially exposed to the outside to recognize a user and opening the input port by operating the input unit, depending on whether recognizing a user.

The sensing control unit may further include a specific transceiver and may transmit a collection amount of the load collected in the collecting unit or whether the input unit and the pressing unit are normally operated to a specific server.

In addition, the sensing control unit may include a separate temperature sensor disposed in the case and sensing internal temperature, thereby sensing whether a fire occurs and transmitting whether a fire occurs to the server.

### Advantageous Effects

The load collecting device for solving the problems of the present invention has the following effects.

According to the load collecting device of the present invention, when the load input through the input port is loaded over a predetermined level, it is sensed and the load is compressed by the pressing unit. Further, when the load is loaded over a reference level after compressed over a predetermined level, it is transmitted to the server and the collecting unit is replaced. Accordingly, there is an advantage that the load can be efficiently collected and easily managed.

Further, there is an advantage that resistance acting in the pressing member when loads are pressed is measured, and when resistance over a predetermined setting measurement value act, pressing is stopped, damage of the loads can be prevented.

The effects of the present invention are not limited to those described above and other effects not stated herein may be made apparent to those skilled in the art from claims.

### DESCRIPTION OF DRAWINGS

The accompanying drawings of this specification exemplify preferred embodiments and help easy understanding of the present invention together with the following detailed description, so the present invention should not be construed as being limited to the drawings.

FIG. 1 is a view schematically showing the external shape of a load collecting device according to the present invention;

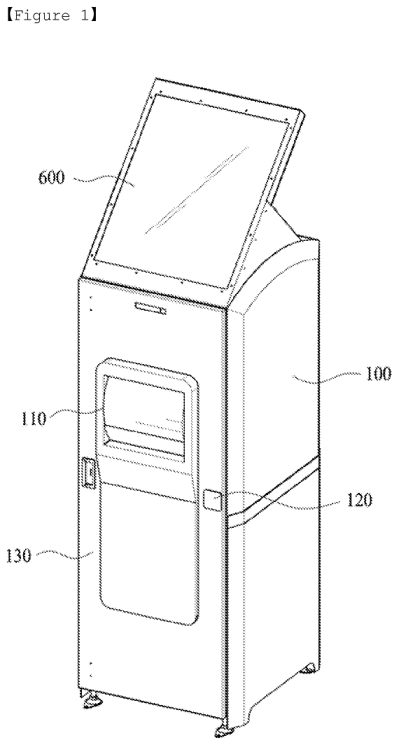

FIG. 2 is a rear perspective view showing the rear of the load collecting device of FIG. 1;

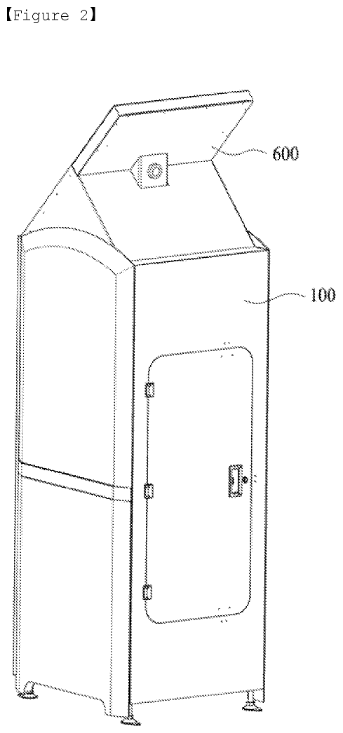

FIG. 3 is an exploded perspective view showing the internal structure of the load collecting device of FIG. 1;

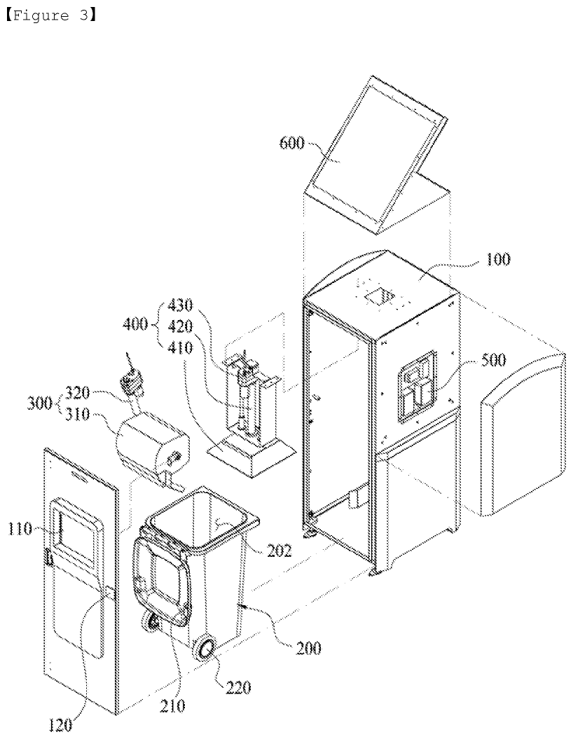

FIG. 4 is a view showing the operation state of the load collecting device of FIG. 1;

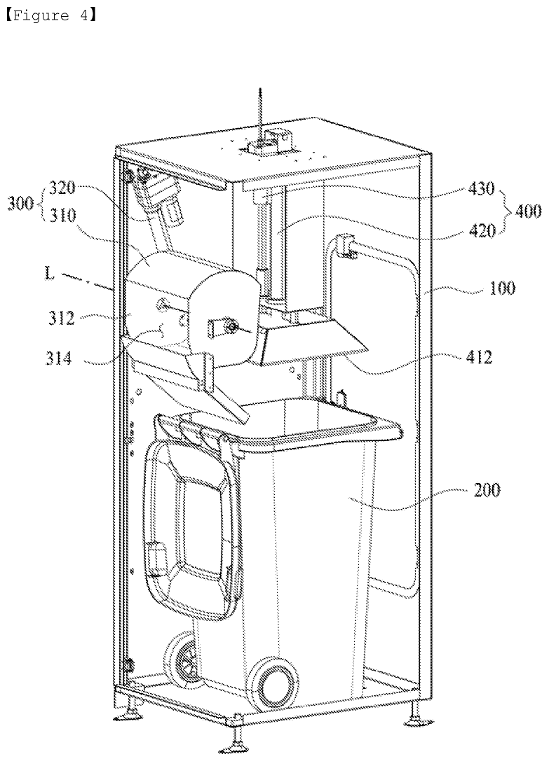

FIG. 5 is a view showing the state in which a load input through an input port is moved to a collecting unit of FIG. 4;

FIG. 6 is a view showing the state in which the collection amount of loads is sensed by the load collecting device of FIG. 1;

FIG. 7 is a view showing the state in which a pressing unit in the load collecting device of FIG. 6; and

FIG. 8 is a view showing a process of calculating a load amount on the basis of the operation time of the pressing unit in the load collecting device of FIG. 1.

### BEST MODE

Hereafter, an exemplary embodiment that can achieve the objectives of the present invention in detail is described with reference to the accompanying drawings. In the description of the embodiment, the same names and reference numerals are used for the same components, and an additional description thereof will be omitted.

A load collecting device according to the present invention, which is a device for collectively transporting loads by loading and keeping loads therein through an input port, may be generally used for daily waste collection, etc.

In particular, using the load collecting device for waste collection is exemplified in the description of the present invention.

The present invention, in a broad meaning, includes a case 100, a collecting unit 200, an input unit 300, a pressing unit 400, and sensing control unit 500, and loads T are collected inside.

The case 100 is formed in a shape surrounding the entire device and the inside thereof is partially divided, so the collecting unit 200 is disposed at the lower portion, and the input unit 300, the pressing unit 400, and the sensing control unit 500 are accommodated at the upper portion. The case 100 is made of metal or synthetic resin to have resistance against external shock.

In detail, the case 100, as shown in the figures, is formed in a rectangular shape and has an input port 110 through which the loads T are input is formed at the upper portion of the front to be able to be selectively opened.

The case 100 is formed in a common box shape and configured to protect the loads T accommodated therein, etc. Further, the external shape may be formed in various shapes such as a polygon other than a simple rectangular shape, and a door 130 that can be opened is formed at a portion separately from the input port 110 so that when the internal parts, etc. are damaged, they can be easily repaired and replaced.

The input unit 300 connected with the input port 110 is selectively operated later, thereby transferring the loads T into the case 100.

In this embodiment, the case 100 includes a separate recognizer 120 so that the input port 110 can be opened when the recognizer 120 senses a user. The recognizer 120 includes a radio wave sensor and is configured to be able to selectively operate by sensing a motion of a user. Accordingly, a user can open the input port 110 using even only a simple motion without separately inputting information.

Further, the case 100 according to this embodiment may additionally have a separate identifier (not shown) disposed adjacent to the input port 110 to identify users.

Various means such as a fingerprint, an ID car, RF communication, or a credit card may be applied to the identifier to identify users, and payment may be additionally possible. In addition, when the load collecting device is installed in a large residential district or apartment district, it is possible to record the source of the loads T, which is input through the input port 110, and find out the amount of a load T for each user.

As described above, the case 100 is formed in a long rectangular shape, the input port 110 is formed at the upper portion of the front, and the collecting unit 200, the input unit 300, the pressing unit 400, and the sensing control unit 500 are accommodated in the case 100. The case 100, as shown in the figures, is configured such that at least a portion of the front and the rear can be selectively opened so that the collecting unit 200 can be taken out of the case 100.

Meanwhile, the collecting unit 200, which is configured to collect the loads T at the lower portion in the case 100, is disposed in the case 100, is open on the top, and has an accommodation space 202 for accommodating the loads T.

In detail, the collecting unit 200 is formed in the shape of common garbage can and is disposed at the lower portion in the case 100 with the top open. The collecting unit 200 is disposed at a position where the load T input through the input port 110 drops, and the load T is collected in the collecting unit 200 through the open top.

In this embodiment, the collecting unit 200 has a separate cover 210, so whether to open the top can be selectively controlled, and the collecting unit 200 is formed to be long up and down. The collecting unit 220 has wheels at the lower portion so it can be selectively inserted into or taken out of the case 100.

As described above, the collecting unit 200 according to the present invention has the accommodation space 202 therein and collects the load T therein through the open top.

Meanwhile, the input unit 300 is disposed adjacent to the input port 110 in the case 100, and controls whether to open the input port 110 and simultaneously transfers the input load T to the collecting unit 200.

In detail, the input unit 300 is at least partially rotated adjacent to the input port 110, and blocks or opens the input port 110 such that the load T is accommodated, depending on the rotation state.

In the present invention, the input unit 300, in a broad meaning, includes a rotary bowl 310 and a driver 320.

The rotary bowl 310 has a seat space 314 in which the load T is seated, an opening 312 opened at a side, and a rotary shaft L disposed in the width direction, and is rotated in the case 100.

In detail, the rotary bowl 310 according to the present invention is formed in a ‘U’ shape, and has the seat space 314 therein and the opening 312 on a side of the circumference. In this embodiment, the rotary bowl 310, as shown in the figures, has a top and a bottom around the opening 312, and the load T is seated on the bottom in the seat space 314.

The rotary bowl 310 formed in this way is rotated up and down around the rotary shaft L, and the opening 312 and the input port 110 selectively communicate with each other, depending on the rotation state.

Meanwhile, the driver 320 is disposed in the case 100 and rotates the rotary bowl 310. In detail, the driver 320 is a common motor or actuator, is connected with the rotary bowl 310 in the case 100, and adjusts the rotation angle of the rotary bowl 310.

In this embodiment, the driver 320 is configured like an actuator and is coupled to the rotary bowl 310 with a side fixed in the case 100 and the other side spaced apart from the rotary shaft L. Accordingly, as the driver 320 contracts and stretches, the rotary bowl 310 is rotated up and down, so the opening 312 is positioned to face the collecting unit 200 or the input port 110.

Accordingly, the driver 320 selectively rotates the rotary bowl 310, and accordingly, the rotary bowl 310 blocks the input port 110 or the opening and the input port 110 communicate with each other, depending on the rotation angle of the rotary bowl.

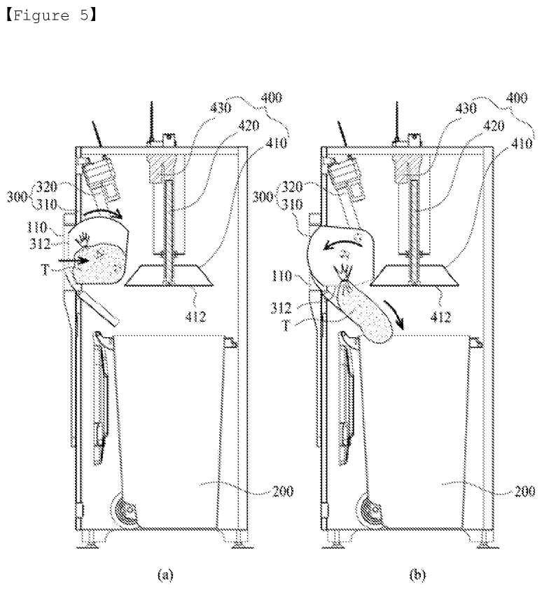

In this embodiment, the rotary bowl 310, as described above, has a top and a bottom around the opening 312, and the opening 312 is positioned to face the front and communicates with the input port 110, as in (a) of FIG. 5, the load T is temporarily accommodated in the seat space 314 through the input port 110.

In this case, the rotary bowl 310 not only simply accommodates the load T, but also measures the weight of the input load T, so it is possible to check and record the amount of the load T input by a user.

Further, as in (b) of FIG. 5, when the opening 312 of the rotary bowl 310 is rotated downward, the load T seated in the seat space 314 drops down through the opening 312. Further, the top of the rotary bowl 310 rotates and blocks the input port 110.

That is, the opening 312 of the rotary bowl 310 is used to input the load T or transfer the input load T to the collecting unit 200, and the top of the rotary bowl 310 may function as a blocking wall that blocks the input port 110, depending on the rotation state.

Accordingly, the rotary bowl 310 temporarily accommodates the load T with the seat space 314 exposed to the outside through the opening 312, and later transfers the load T to the collecting unit 200.

As described above, the input unit 300 includes the rotary bowl 310 and the driver 320, and accommodates and transfers the load T to the collecting unit 200 by opening the input port 110, depending on the rotation state of the rotary bowl 310.

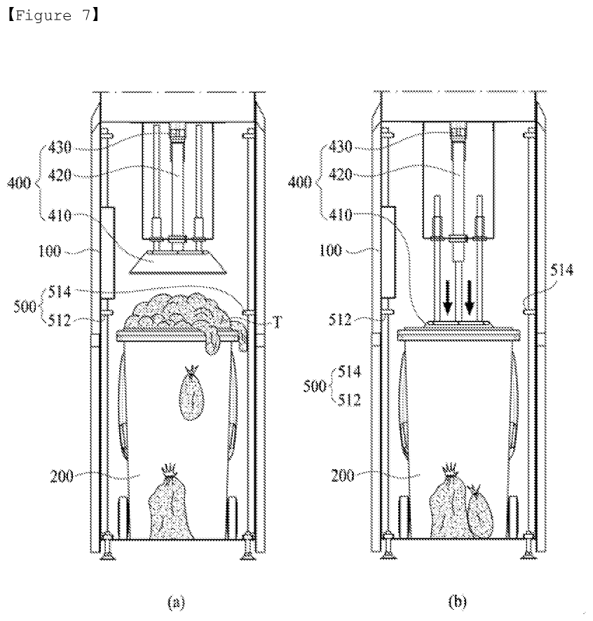

Meanwhile, the configuration of the pressing unit 400 according to the present invention is described with reference to FIG. 7. The pressing unit 400, which is configured to reduce a loading volume by selectively pressing the load T accommodated in the collecting unit 200 in the case 100, includes, in a broad meaning, a pressing member 410, a stretcher 420, and a measurer 430.

The pressing member 410 has a predetermined area over the collecting unit 200 and presses the load T by selectively moving up and down.

In detail, the pressing member 410 is disposed over the collecting unit 200 to face down, and presses the load T accommodated in the collecting unit 200 with a pressing surface 412 in contact with the load T, thereby pressing the load into the collecting unit 200. At this time, the pressing member 410 presses the load T through the pressing surface 412 at the lower portion by selectively moving up and down over the collecting unit 200.

In this embodiment, the pressing member 410 is disposed at a lower portion such that the pressing surface 412 faces the top of the collecting unit 200, and has a shape and a size corresponding to the shape of the top of the collecting unit 200.

Accordingly, the pressing member 410 at least partially compresses the load T into the collecting unit 202 through the top of the collecting unit 200 by moving down.

Meanwhile, the stretcher 420, which adjusts ascending and descending of the pressing member 410, is configured to be able to stretch and contract over the pressing member 410.

In detail, the pressing member 410 is selectively operated by the sensing control unit 500 connected to the pressing member 410 in the case 100 as described below. In the present invention, the driver 320 is formed to be long up and down, and a side thereof is fixed to the case 100 and the other side is coupled to the pressing member 410. Further, the stretcher 420 is operated by the sensing control unit 500 to move up and down the pressing member 410.

The stretcher 420 may be configured in various types, and is configured as an actuator or is composed of a plurality of frames rotatably crossing each other, thereby moving up and down the pressing member 410 toward the collecting unit 200.

In this embodiment, the stretcher 420 is an actuator including a hydraulic cylinder or a linear actuator. In particular, when the stretcher 420 is a linear actuator, it can operate faster than a common configuration using a gear or a timing belt, so it is possible to precisely adjust up/down movement of the pressing member 410.

Meanwhile, the measurer 430 is disposed over the stretcher 420, measures resistance acting in the stretcher 420, and when resistance over a predetermined level acts, the measurer 430 transmits this fact to the sensing control unit 500.

In detail, the measurer 430 is connected with the stretcher 420 in the case 100, and measures and compares resistance acting in the pressing member 410 with a predetermined setting value when the pressing member 410 moves down and presses the load T.

Here, the measurer 430 measures resistance that is generated when the pressing member 410 moves downs and comes in contact with the load T, and returns the pressing member 410 to the initial position without further compressing the load T when it is determined that the resistance is the setting value or more.

At this time, the measurer 430 measures the resistance in different ways, depending on the kinds of the stretcher 420, and when the measurer 430 is a linear actuator, resistance is measured on the basis of the amount of current instantaneously consumed to operate the pressing member 410. Further, when the stretcher 420 is a hydraulic actuator, the measurer 430 determines whether pressure at a predetermined level or more is applied through a separate hydraulic sensor.

That is, the measurer 430 may be applied in various types, depending on the kind of the stretcher 420, measures resistance that acts when the stretcher 420 moves down the pressing member 410, and stops moving down the pressing member 410 through the sensing control unit 500 when the measured resistance is the setting value or more.

As described above, the pressing unit 400 according to the present invention includes the pressing member 410, the stretcher 420, and the measurer 430, and stops moving down the pressing member 410 and returning the pressing member 410 to the initial position when resistance measured by the measurer 430 is the setting value or more, thereby stopping pressing the load T.

Further, the stretcher 420 is configured to press the load T by moving down the pressing unit 400 by a predetermined length. In detail, when the load T loaded in the collecting unit 200 is a predetermined level or less, the measured resistance is maintained under the setting value even though the pressing member 410 moves down and presses the load T, so the descending distance of the pressing member 410 is set as a condition for returning the pressing member 410 to the initial position so that the pressing member 410 is moved up and down later.

Accordingly, when the resistance measured by the measurer 430 when the pressing member 410 moves down is the setting value or more or when the pressing member 410 moves down by the predetermined length of the stretcher 420, the pressing unit 400 returns to the initial position.

In this embodiment, when pressing the load T, the pressing unit 400 presses the load only by about 300 mm corresponding to 30% of the upper portion of the collecting unit 200, thereby preventing damage to the plastic container or a problem when the load T is taken out of the container due to excessive compression.

In addition, in the present invention, the pressing unit 400 may further include a separate encoder (not shown).

The encoder is disposed on the stretcher 420 and can measure the adjustment length of the stretcher 420. When the pressing member 420 stops moving down and returns to the initial position, the encoder measures the descending length from the initial position to the final descending position.

Further, the encoder transmits the measured descending length of the pressing member 410 to the control unit 500 so that the amount of the load T accommodated in the collecting unit 200 can be calculated.

As described above, the pressing unit 400 according to the present invention includes the pressing member 410, the stretcher 420, and the measurer 430, and stops moving down and returning the pressing member 410 to the initial position when the pressing member 410 moves down by a setting length of the stretcher 420 or the resistance measured by the measurer 430 is the setting value or more, thereby preventing excessive compression of the load T.

Meanwhile, the sensing control unit 500 according to the present invention senses the load amount of the load T accommodated in the collecting unit 200 and controls the pressing unit 400 so as to selectively press the load T.

In detail, the sensing control unit 500 further includes, in a broad meaning, a load sensor 510, a controller, a transceiver, and a temperature sensor.

The load sensor 510 measures the collected amount of the load T by sensing the height of the load T accommodated in the collecting unit 200 in the case 100. The load sensor 510 may be a common optical sensor, and operates the pressing unit 400 when the level of the load T accommodated in the collecting unit 200 is a predetermined height or more.

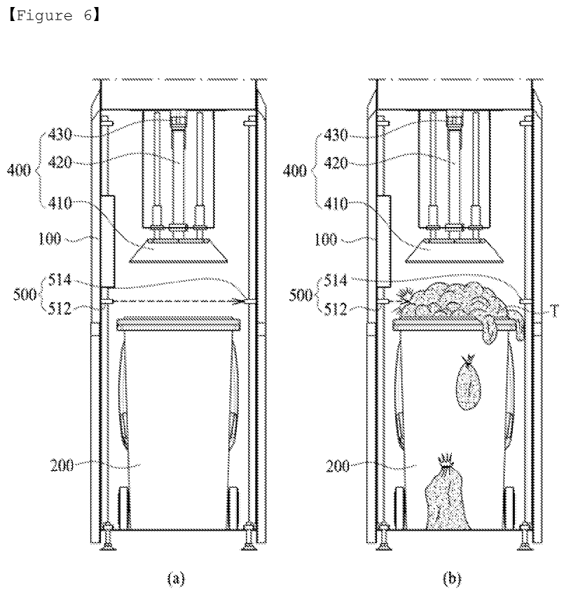

In detail, in the present invention, the load sensor 510, as shown in FIG. 6, is composed of a light emitter 512 and a light receiver 514 disposed to face each other in the case 100, and emits a measurement beam. In this case, the light emitter 512 and the light receiver 514 are disposed to face each other in the case 100 at the same height as or higher than the upper end of the collecting unit 200.

Accordingly, as in (b) of FIG. 6, when the load T is collected over a predetermined height in the collecting unit 200 and protrudes over the open top of the collecting unit 200, the load sensor 510 senses and transmits this fact to the controller.

Although the load sensor 510 is composed of one light emitter 512 and one light receiver 514 in this embodiment, it may be configured in a plurality of sets, thereby being able to more precisely determine whether the load T is loaded outside the collecting unit 200.

As described above, when the measurement beam is not received over a predetermined time, the load sensor 510 determines that the load T is loaded outside the collecting unit 200 and transmits this fact to the controller such that the load T is pressed.

Meanwhile, the controller, which controls the operation of the pressing unit 400, controls the pressing unit 400 by receiving a signal, which shows that the load T is loaded outside the collecting unit 200, from the load sensor 510.

In this case, the controller controls the pressing unit 400 to move down at a uniform speed, and calculates the collection amount of the load T loaded in the collecting unit 200 on the basis of the time taken by the pressing unit 400 to return to the initial position after starting moving down.

In detail, when the load T is loaded outside the collecting unit 200 as in (a) of FIG. 7, the controller receives a signal from the load sensor 510, and accordingly, as shown in (b) of FIG. 7, the controller moves down the pressing member 410, thereby compressing the load T.

In this case, the pressing unit 400 not only simply receives a signal from the load sensor 510, but also receives the information about the resistance acting in the pressing unit 400 from the measurer 430 when the pressing unit 400 is operated, whereby whether resistance over the setting value acts is determined.

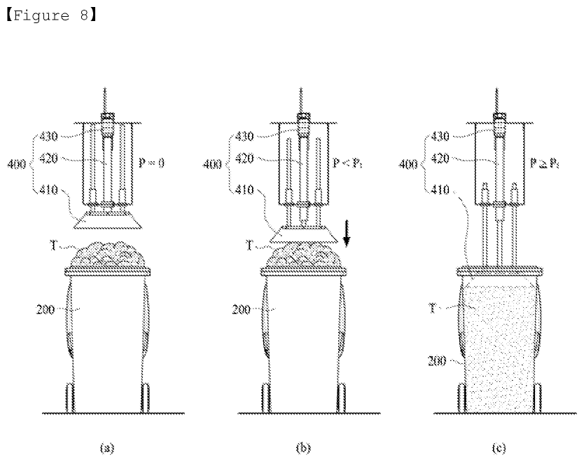

In detail, referring to FIG. 8, the controller receives a signal, which shows that the load T is loaded outside the collecting unit 200 as in (a) of FIG. 8, from the load sensor 510. In this case, the pressing member 410 is positioned at the initial position and the resistance P acting in the pressing member 410 is zero.

In this case, the controller moves down the pressing member 410 such that the pressing surface 412 of the pressing member 410 comes in contact with the load T, as in (b) of FIG. 8. This is the point in time at which the pressing member 410 starts pressing in contact with the load T, and in this state, the measurer 430 measures the resistance acting in the pressing member 410.

At this time, when the resistance P measured by the measurer 430 is smaller than the setting value P1, the controller keeps moving down the pressing member 410 to compress the load T.

However, when the load T is pressed over a predetermined level, as in (c) of FIG. 8, the value of the resistance P measured by the measurer 430 increases, so the controller stops moving down and returns the pressing member 410 to the initial position when the value of the resistance P is the setting value P1 or more.

That is, the controller stops pressing of the load T when the resistance P measured by the measurer 430 is the setting value P1 or more.

Further, the controller controls the pressing member 410 to move down at a uniform speed, and calculates the collection amount of the load T loaded in the collecting unit 200 on the basis of the time taken by the pressing unit 400 to return to the initial position after starting moving down.

As described above, the controller selectively operates the pressing unit 400, compresses the load T such that the load T is not damaged when the pressing member 410 moves down, and calculates the collection amount of the load T on the basis of information collected from the load sensor 510 and the measurer 430.

In addition, the controller controls the pressing member 410 to press the load T collected in the collecting unit 200, and controls the device not to further collect the load T when the load T is collected over a predetermined level.

Meanwhile, the sensing control unit 500 further includes a separate transceiver (not shown) in addition to the load sensor 510 and the controller.

The transceiver transmits the collection amount of the load T collected in the collecting unit 200 or whether the input unit 300 and the pressing unit 400 are normally operated to a sever (not shown). In detail, the transceiver is connected with the server and transmits information about the inside of the load collecting device or receives order from the outside.

In particular, when the load amount of the load T collected in the collecting unit 200 is a predetermined level or more, the controller transmits the information to the server through the transceiver and the load T collected in the collecting unit 200 is taken by a specific vehicle or collecting means (not shown).

The sensing control unit 500 according to the present invention further includes a separate temperature sensor (not shown), which is disposed in the case 100, thereby sensing whether a fire occurs. In detail, the temperature sensor senses temperature in the case 100 and accordingly senses whether a fire occurs. If the temperature sensor senses temperature over a predetermined level, the temperature sensor transmits the information to the server through the transceiver, thereby being able to prevent a fire. Further, when sensing a fire through the temperature sensor, the controller can inform a nearby firehouse of occurrence of a fire through the sever.

Further, when the temperature sensor senses a fire, the controller blocks the top of the collecting unit by moving down the pressing member, thereby minimizing inflow of oxygen from the outside and preventing propagation of the fire.

As described above, the sensing control unit 500 according to the present invention includes the load sensor 510, the controller, the transceiver, and the temperature sensor. Accordingly, it is possible to efficiently collect the load T by selectively compressing the load T collected in the collecting unit 200, depending on the height of the load T. Further, it is possible to prevent a fire in the device or continuously manage the device by transmitting information about the load amount of the load T and whether the device normally operates to a separate server.

As described above, the load collecting device according to the present invention includes the case 100, the input unit 300, the collecting unit 200, the pressing unit 400, and the sensing control unit 500, collects the load T in the collecting unit 200, and selectively presses the load T, thereby being able to increase the collection amount.

Meanwhile, the load collecting device according to the present invention further includes a separate energy storage unit 600 in addition to the configuration described above.

The energy storage unit 600, which is disposed in the case 100 and provides power for operating the configuration described above, collects energy from the outside or stores energy using a separate battery (not shown).

In detail, the energy storage unit 600, as shown in the figures, includes a collector collecting energy, and a battery. At least one or more collectors are disposed on the case 100, as shown in the figures, and collect and convert sunlight or solar heat into power. The collector has a predetermined level of area, produces power using sunlight or solar heat, and transmits the produced power to the battery to store it.

In this embodiment, the collector has a solar panel on the front surface and is disposed to have an inclination to reduce foreign substances that stick thereon.

The battery may be additionally supplied with power from the outside in addition to the power collected through the collector. In particular, in an area to which sufficient power is not supplied by only the collector (a building-dense area in a city, a forest-dense area in a park, etc.), power is supplied from the outside and used with the battery.

As described above, the energy storage unit 600 includes the collector and the battery, and produces and stores energy therein using solar heat or sunlight to use the energy as power.

In this embodiment, when the amount of generated power is small even though there is no rain or cloud, the energy storage unit 600 recognizes an abnormal problem and transmits the information to a specific server using the charge state of the battery and weather data of each area. Accordingly, a manager can solve the problem later by checking the site.

In particular, when the collector produces power using solar generation, but when users put dirt on the collector, when the collector is fully covered with excrements of birds, or when the panel is contaminated by yellow sand, it is required to directly repair the collector, so a manager is informed of this situation to be able to check the site.

According to the load collecting device of the present invention, when the load T input through the input port 110 is loaded over a predetermined level, the load is sensed and compressed by the pressing unit 400. Further, when the load T is loaded over a reference level after compressed over a predetermined level, it is transmitted to the server and the collecting unit 200 is replaced. Accordingly, there is an advantage that the load T can be efficiently collected and easily managed.

Although preferred embodiments of the present invention were described above, it would be apparent to those skilled in the art that the present invention may be embodied in other specific types without departing from the scope or spirit other than the embodiments described above. Accordingly, the embodiments described above should be considered as exemplifying rather than limiting, so the present invention may be changed within the range of the claims and the equivalent range without being limited to the above description.

### DESCRIPTION OF THE REFERENCE NUMERALS IN THE DRAWINGS

100: case
110: input port
120: recognizer
200: collecting unit
300: input unit
310: rotary bowl
320: driver
400: pressing unit
410: pressing member
420: stretcher
430: measurer
500: sensing control unit
510: load sensor
600: energy storage unit
T: load

1. A load collecting device comprising:
a case having an input port formed on one side thereof into which a load is put;
a collecting unit disposed inside the case, and having an open top and an accommodation space which accommodates the load;
an input unit disposed adjacent to the input port in the case, selectively rotating to open the input port, and transferring the load to the collecting unit;
a pressing unit disposed on the top of the collecting unit and pressing the load accommodated in the collecting unit by at most partially moving down; and
a sensing control unit sensing a load amount of the load accommodated in the collecting unit and controlling the pressing unit so as to selectively press the load.

2. The load collecting device of claim 1, wherein the sensing control unit comprises:
a load sensor sensing a load height of the load accommodated in the collecting unit; and
a controller controlling whether to operate the pressing unit.

3. The load collecting device of claim 2, wherein the sensing control unit stops moving down the pressing unit and returns the pressing unit to an initial position when resistance acting due to the load is a predetermined setting value or more when the pressing unit is moved down.

4. The load collecting device of claim 3, wherein the controller controls the pressing unit to move down at a uniform speed and calculates a collection amount of loads loaded in the collecting unit on the basis of time taken by the pressing unit to return to the initial position after starting moving down.

5. The load collecting device of claim 3, wherein the controller calculates a collection amount of loads loaded in the collecting unit by sensing a descending length of the pressing unit from the initial position to the final descending position.

6. The load collecting device of claim 1, wherein the input port comprises:
a rotary bowl having a seat space in which the load is seat, having an opening on a side, having a rotary shaft disposed in a width direction, and rotating in the case; and
a driver disposed in the case and rotating the rotary bowl,
wherein the rotary bowl blocks the input port or the opening and the input port communicate with each other, depending on a rotation angle of the rotary bowl.

7. The load collecting device of claim 6, wherein the rotary bowl has a top and a bottom around the opening, and when the opening is rotated down, the load seated in the seat space drops down and the top blocks the input port.

8. The load collecting device of claim 6, wherein the rotary bowl has a bottom and a top around the opening, and when the opening is positioned to face a front and communicates with the input port, the load is seated in the seat space.

9. The load collecting device of claim 1, wherein the pressing unit comprises:
a pressing member having a predetermined area over the collecting unit and pressing the load by selectively moving up and down;
a stretcher configured to be able to selectively stretch and contract over the pressing member and moving up and down the pressing member; and
a measurer measuring resistance acting when the pressing member presses the load, and informing the sensing control unit that the resistance is a predetermined setting value or more when the resistance is the predetermined setting value or more so that the pressing member is returned to an initial position.

10. The load collecting device of claim 1, further comprising at least one or more energy storage units disposed on the case, collecting and converting sunlight or solar heat into power, and storing the power.

11. The load collecting device of claim 1, wherein the case further includes a recognizer at least partially exposed to the outside to recognize a user and opening the input port by operating the input unit, depending on whether recognizing a user.

12. The load collecting device of claim 1, wherein the sensing control unit further includes a specific transceiver and transmits a collection amount of the load collected in the collecting unit or whether the input unit and the pressing unit are normally operated to a separate server.

13. The load collecting device of claim 12, wherein the sensing control unit includes a separate temperature sensor disposed in the case and sensing internal temperature, thereby sensing whether a fire occurs and transmitting whether a fire occurs to the server.
